(19) United States
(12) Patent Application Publication
(10) Pub. No.: US 2025/0141141 A1
(43) Pub. Date: May 1, 2025

(54) TERMINAL

(71) Applicant: JAPAN AVIATION ELECTRONICS INDUSTRY, LIMITED, Shibuya-ku, Tokyo (JP)

(72) Inventors: Yuki SUDA, Tokyo (JP); Chikara KAWAMURA, Tokyo (JP); Yuta SEKIMURA, Tokyo (JP)

(73) Assignee: JAPAN AVIATION ELECTRONICS INDUSTRY, LIMITED, Shibuya-ku, Tokyo (JP)

(21) Appl. No.: 18/721,176

(22) PCT Filed: Oct. 28, 2022
(86) PCT No.: PCT/JP2022/040361

§ 371 Date: Jan. 3, 2025

(30) Foreign Application Priority Data
Dec. 20, 2021 (JP) 2021-206097

(51) Int. Cl. H01R 13/05

(52) U.S. Cl. CPC H01R 13/05

(57) ABSTRACT

A terminal is connectable with a mating terminal in a front-rear direction. The terminal has a base portion, a plurality of supporting portions and a plurality of contact points. The base portion has a cylindrical shape. Each of the supporting portions is resiliently deformable and extends forward in the front-rear direction from the base portion. The supporting portions are arranged in a circumferential direction about an axis parallel to the front-rear direction. Each of the contact points is movable in a radial direction perpendicular to the front-rear direction. Each of some of the contact points is positioned rearward of any remaining ones of the contact points in the front-rear direction. In at least one of the circumferential direction and the radial direction, a size of each of some of the supporting portions is, at least in part, smaller than a size of any remaining ones of the supporting portions.

### TECHNICAL FIELD

This invention relates to a terminal which has a plurality of supporting portions and a plurality of contact points.

### BACKGROUND ART

Referring to FIG. 24, Patent Document 1 discloses a terminal 900 of this type. Referring to FIGS. 23 and 24, the terminal 900 is connectable with a mating terminal 970 in an X-direction, or in a mating direction. The terminal 900 has a base portion 910, a plurality of supporting portions 920, 922 and 924, a plurality of contact points 930, 932 and 934, a plurality of front end portions 940, 942 and 944, a slit 950 and a coupling portion 960. The base portion 910 has a cylindrical shape. Each of the supporting portions 920, 922 and 924 is resiliently deformable and extends in a positive X-direction from the base portion 910. The supporting portions 920, 922 and 924 are arranged in a circumferential direction about an axis parallel to the X-direction. Each of the contact points 930, 932 and 934 is brought into contact with the mating terminal 970 when the terminal 900 is connected with the mating terminal 970. The contact points 930, 932 and 934 are supported by the supporting portions 920, 922 and 924, respectively. Each of the contact points 930, 932 and 934 is movable in a radial direction perpendicular to the X-direction. The contact point 930 is positioned in a negative X-direction beyond any of the contact points 932 and 934. The front end portions 940, 942 and 944 extend in the positive X-direction from the contact points 930, 932 and 934, respectively. The coupling portion 960 couples the front end portions 940, 942 and 944 with each other except for the slit 950.

In the terminal 900 of Patent Document 1, positions of the contact points 930, 932 and 934 in the mating direction are different from each other. This reduces an insertion force of the terminal 900 when the terminal 900 is mated with the mating terminal 970.

### PRIOR ART DOCUMENTS

### Patent Document(s)

Patent Document 1: U.S. Pat. No. 10,224,659

### SUMMARY OF INVENTION

### Technical Problem

In the terminal 900 of Patent Document 1, contactability of the contact points 930, 932, 934 might be reduced by repeated mating of the terminal 900 and the mating terminal 970.

It is therefore an object of the present invention to provide a terminal in which contactability of its contact point is not reduced even if the terminal is repeatedly mated with a mating terminal.

### Solution to Problem

In the terminal 900 of Patent Document 1, the supporting portions 922 and 924, which are in close proximity of the slit 950, are easily resiliently deformed while the supporting portions 922 and 924, which are farthest from the slit 950, are not easily resiliently deformed. In other words, contact pressure of each of the contact points 932 and 934, which are in close proximity of the slit 950, is low while contact pressure of each of the contact points 932 and 934, which are farthest from the slit 950, is high. Thus, the supporting portions 922 and 924 farthest from the slit 950 are easily degraded, and the contact points 932 and 934 farthest from the slit 950 are easily abraded.

Although the terminal 900 of Patent Document 1 is configured so that the front end portions 940, 942 and 944 are coupled with each other by the coupling portion 960 expect for the slit 950, one possible modification of the terminal 900 is that the front end portions 940, 942 and 944 are not coupled with each other while the supporting portions 920, 922 and 924 are resiliently deformable independently of each other. In that possible modification, contact pressure of the contact point 930, which is supported by the supporting portion 920 having a short spring length, is higher than contact pressure of the contact point 932 which is supported by the supporting portion 922 having a long spring length. Thus, in this case, the supporting portion 920 is easily degraded and the contact point 930 is easily abraded.

Specifically, if a terminal is configured so that its supporting portions have the same thickness and width while positions of its contact points are deviated from each other in a mating direction, the terminal inevitably has both of the supporting portion, which supports the contact point whose contact pressure is high, and the supporting portion which supports the contact point whose contact pressure is low.

In order to avoid the aforementioned problem, the inventors have conceived that contact pressure of a contact point, which is expected to be high, is reduced by reducing a size of a supporting portion, which supports the contact point, in at least one of a circumferential direction and a radial direction as compared to a size of any of remaining supporting portions in the at least one of the circumferential direction and the radial direction. The present invention stems from the conceiving as described above.

An aspect of the present invention provides a terminal connectable with a mating terminal in a front-rear direction. The terminal has a base portion, a plurality of supporting portions and a plurality of contact points. The base portion has a cylindrical shape. Each of the supporting portions is resiliently deformable and extends forward in the front-rear direction form the base portion. The supporting portions are arranged in a circumferential direction about an axis parallel to the front-rear direction. Each of the contact points is brought into contact with the mating terminal when the terminal is connected with the mating terminal. The contact points are supported by the supporting portions, respectively. Each of the contact points is movable in a radial direction perpendicular to the front-rear direction. Each of some of the contact points is positioned rearward of any of remaining ones of the contact points in the front-rear direction. In at least one of the circumferential direction and the radial direction, a size of each of some of the supporting portions is, at least in part, smaller than a size of any of remaining ones of the supporting portions.

### Advantageous Effects of Invention

The terminal of the present invention is configured so that the size of each of some of the supporting portions is, at least in part, smaller than the size of any of the remaining ones of the supporting portions in the at least one of the circumferential direction and the radial direction. This enables the terminal of the present invention to reduce contact pressure of the contact point whose contact pressure is expected to be high in a case where the supporting portions have the same size as each other. In other words, the terminal of the present invention is configured so that contactability of its contact point is not reduced even if the terminal is repeatedly mated with the mating terminal.

An appreciation of the objectives of the present invention and a more complete understanding of its structure may be had by studying the following description of the preferred embodiment and by referring to the accompanying drawings.

### BRIEF DESCRIPTION OF DRAWINGS

FIG. 1 is a side view showing an assembly according to an embodiment of the present invention. In the figure, a connector is not mated with a mating connector.

FIG. 2 is a front view showing the assembly of FIG. 1.

FIG. 3 is a cross-sectional view showing the assembly of FIG. 2, taken along line A-A.

FIG. 4 is a side view showing the assembly of FIG. 1. In the figure, the connector is mated with the mating connector.

FIG. 5 is a front view showing the assembly of FIG. 4.

FIG. 6 is a cross-sectional view showing the assembly of FIG. 5, taken along line B-B.

FIG. 7 is a perspective view showing a terminal which is included in the connector of the assembly of FIG. 3.

FIG. 8 is a top view showing the terminal of FIG. 7.

FIG. 9 is a side view showing the terminal of FIG. 7.

FIG. 10 is a cross-sectional view showing the terminal of FIG. 9, taken along line C-C.

FIG. 11 is a cross-sectional view showing the terminal of FIG. 9, taken along line D-D.

FIG. 12 is a cross-sectional view showing the terminal of FIG. 9, taken along line E-E.

FIG. 13 is a front view showing the terminal of FIG. 7.

FIG. 14 is a cross-sectional view showing the terminal of FIG. 13, taken along line F-F.

FIG. 15 is a cross-sectional view showing the terminal of FIG. 13, taken along line G-G.

FIG. 16 is a perspective view showing a modification of the terminal of FIG. 7.

FIG. 17 is a top view showing the terminal of FIG. 16.

FIG. 18 is a side view showing the terminal of FIG. 16.

FIG. 19 is a cross-sectional view showing the terminal of FIG. 18, taken along line H-H.

FIG. 20 is a front view showing the terminal of FIG. 16.

FIG. 21 is a cross-sectional view showing the terminal of FIG. 20, taken along line I-I.

FIG. 22 is a cross-sectional view showing the terminal of FIG. 20, taken along line J-J.

FIG. 23 is a partially cross-sectional view showing a terminal and a mating terminal of Patent Document 1.

FIG. 24 is a perspective view showing the terminal of FIG. 23.

### DESCRIPTION OF EMBODIMENTS

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

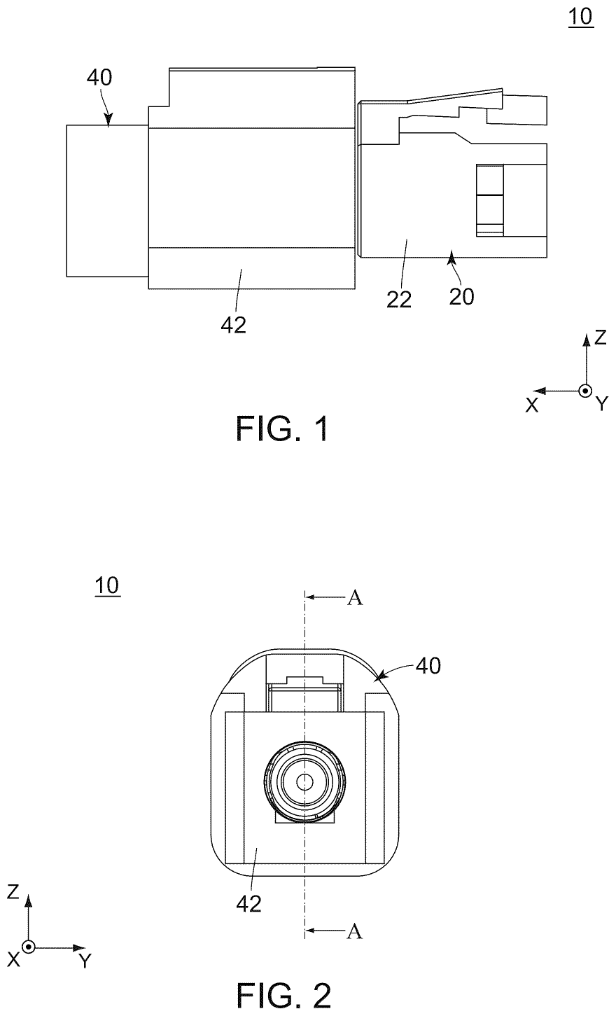

As shown in FIG. 1, an assembly 10 according to an embodiment of the present invention comprises a mating connector 40 and a connector 20.

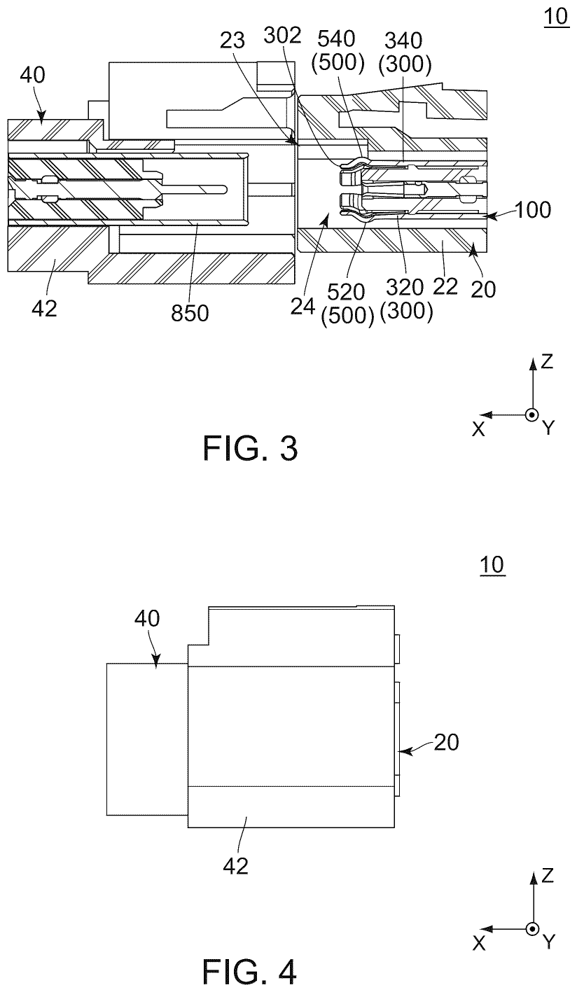

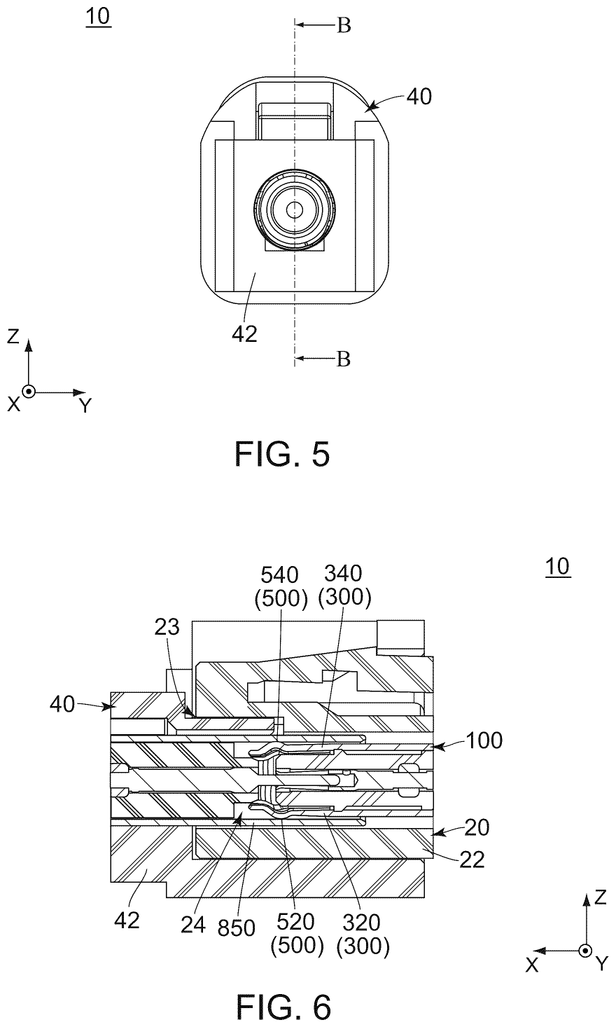

As shown in FIG. 3, the mating connector 40 of the present embodiment comprises a mating holding member 42 and a mating terminal 850.

Referring to FIG. 3, the mating holding member 42 of the present embodiment is made of insulator.

Referring to FIG. 3, the mating terminal 850 of the present embodiment is made of metal. The mating terminal 850 is held by the mating holding member 42.

As understood from FIGS. 1 and 4, the connector 20 of the present embodiment is mateable along a front-rear direction with the mating connector 40 which is positioned forward of the connector 20 in the front-rear direction. In the present embodiment, the front-rear direction is an X-direction. Specifically, forward is a positive X-direction while rearward is a negative X-direction.

As shown in FIG. 3, the connector 20 of the present embodiment comprises a holding member 22 and a terminal 100.

Referring to FIG. 3, the holding member 22 of the present embodiment is made of insulator. The holding member 22 has an opening 23 and a mating terminal accommodating portion 24.

As shown in FIG. 3, the opening 23 of the present embodiment is positioned at a front end of the holding member 22 in the front-rear direction. The opening 23 connects the mating terminal accommodating portion 24 with the outside of the connector 20.

As shown in FIG. 3, the mating terminal accommodating portion 24 of the present embodiment is positioned rearward of the opening 23 in the front-rear direction. As shown in FIG. 6, the mating terminal accommodating portion 24 accommodates a part of the mating terminal 850 when the connector 20 and the mating connector 40 are mated with each other.

Referring to FIGS. 3 and 6, the terminal 100 of the present embodiment is connectable with the mating terminal 850 in the front-rear direction. In other words, the terminal 100 is mated with the mating terminal 850 when the connector 20 is mated with the mating connector 40. The terminal 100 is held by the holding member 22. A part of the terminal 100 is positioned in the mating terminal accommodating portion 24.

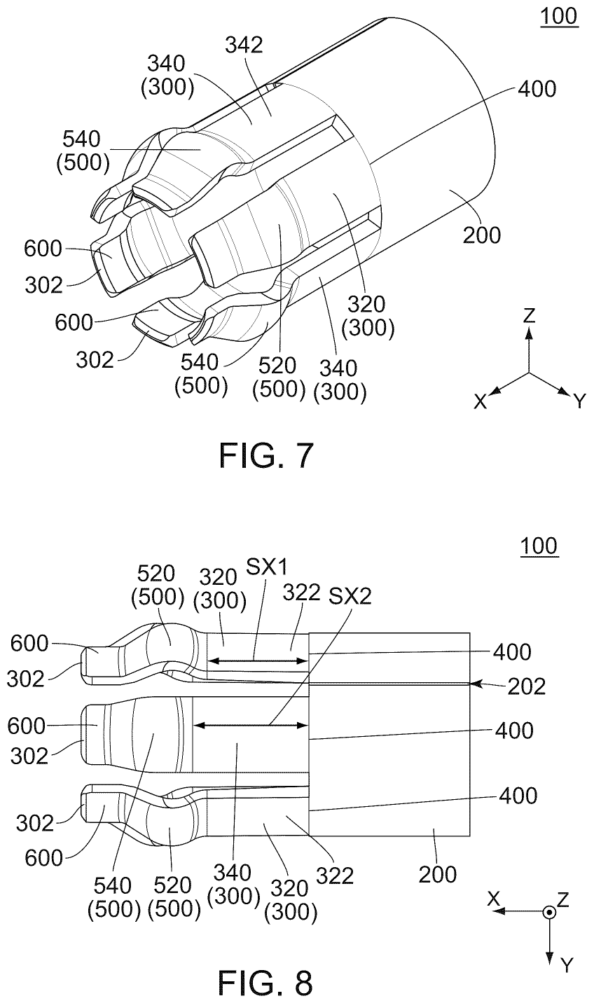

Referring to FIG. 7, the terminal 100 is made of metal. The terminal 100 is made from bent plate. In other words, the terminal 100 is not formed by cutting a metal block.

As shown in FIG. 7, the terminal 100 has a base portion 200, a plurality of supporting portions 300 and a plurality of contact points 500. The base portion 200 has a cylindrical shape.

As shown in FIG. 8, the base portion 200 of the present embodiment extends in the front-rear direction. The base portion 200 defines a rear end of the terminal 100 in the front-rear direction. As understood from FIGS. 8 and 12, the base portion 200 is formed by bending a plate to form the cylindrical shape so that edges of the plate face each other. The base portion 200 has facing portions 202. It is noted that the facing portions 202 may be connected with each other by crimping, welding or the like.

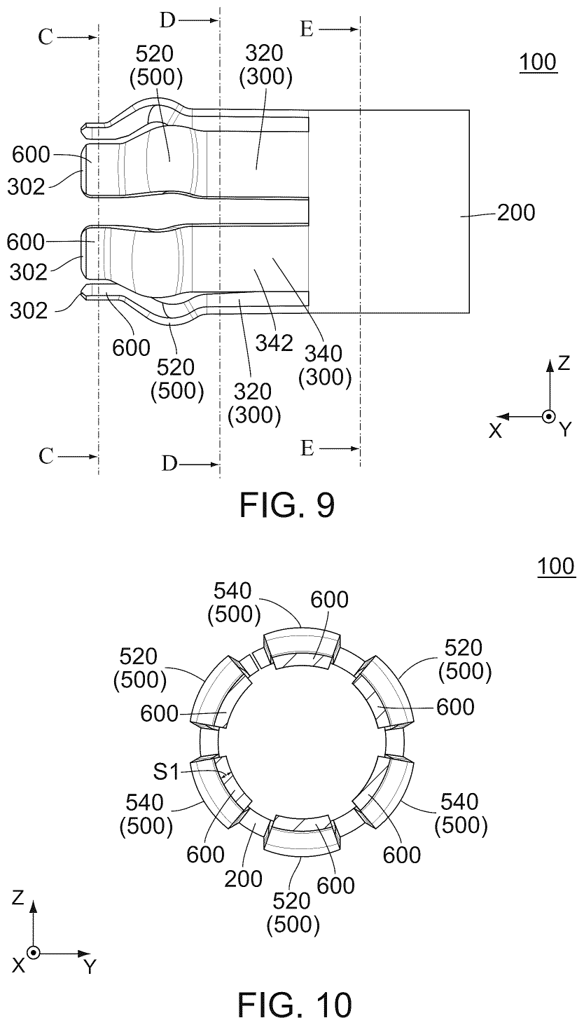

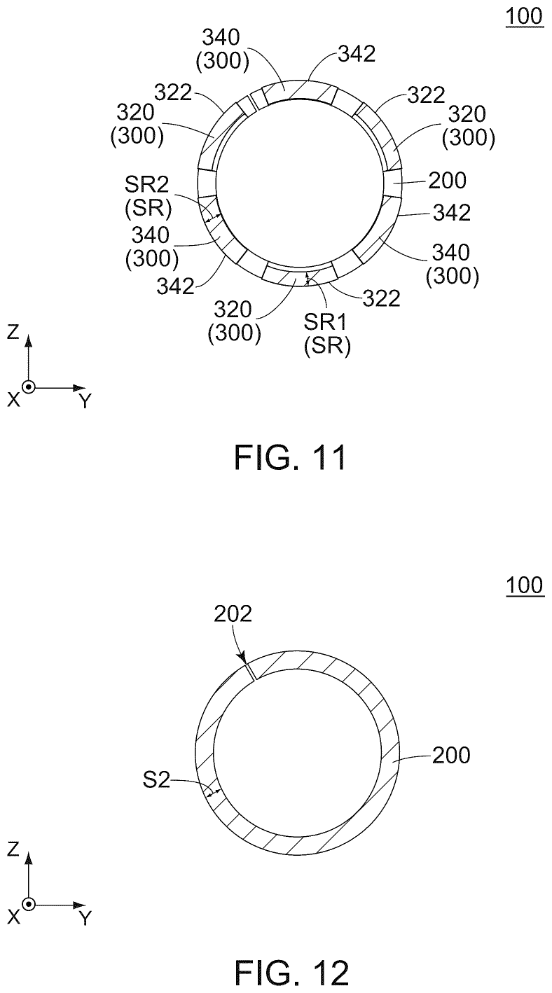

Referring to FIGS. 8 and 9, each of the supporting portions 300 of the present embodiment is resiliently deformable. Each of the supporting portions 300 extends forward in the front-rear direction from the base portion 200. The supporting portions 300 are independent from each other. Boundaries 400 between the base portion 200 and each of the supporting portions 300 are positioned at positions same as each other in the front-rear direction. However, the present invention is not limited thereto, but the boundaries 400 between the base portion 200 and each of the supporting portions 300 may be positioned at positions different from each other in the front-rear direction. As shown in FIG. 11, the supporting portions 300 are arranged in a circumferential direction about an axis parallel to the front-rear direction. In particular, the supporting portions 300 of the present embodiment are arranged at a constant interval in the circumferential direction.

As shown in FIGS. 8 and 9, the plurality of supporting portions 300 include supporting portions 320 and supporting portions 340. Hereinafter, the supporting portion 320 is also referred to as a first supporting portion 320. In addition, the supporting portion 340 is also referred to as a second supporting portion 340. In other words, the plurality of supporting portions 300 include the first supporting portions 320 and the second supporting portions 340.

As shown in FIG. 11, the number of the first supporting portions 320 of the present embodiment is three. However, the present invention is not limited thereto, but the number of the first supporting portions 320 may be other than three. As shown in FIG. 8, in the front-rear direction, a size SX1 of the first supporting portion 320 is smaller than a size SX2 of the second supporting portion 340. That is, in the present embodiment, the first supporting portion 320 is shorter than the second supporting portion 340. The first supporting portion 320 and the second supporting portion 340 are adjacent to each other in the circumferential direction. The first supporting portion 320 has a surface 322 which faces outward in a radial direction.

As shown in FIG. 11, in the radial direction, a size SR1 of the first supporting portion 320 is smaller than a size SR2 of the second supporting portion 340. That is, in the present embodiment, the first supporting portion 320 is thinner than the second supporting portion 340. As shown in FIG. 14, the size SR1 of the first supporting portion 320 in the radial direction is smaller than a thickness S2 of the base portion 200. That is, in the present embodiment, the first supporting portion 320 is thinner than the base portion 200.

As shown in FIGS. 8 and 9, the number of the second supporting portions 340 of the present embodiment is three. However, the present invention is not limited thereto, but the number of the second supporting portions 340 may be other than three. The second supporting portion 340 has a surface 342 which faces outward in the radial direction.

As shown in FIG. 11, the first supporting portions 320 and the second supporting portions 340 are alternately arranged in the circumferential direction. In other words, each of the first supporting portions 320 is arranged between two of the second supporting portions 340 in the circumferential direction, and each of the second supporting portions 340 is arranged between two of the first supporting portions 320 in the circumferential direction.

As shown in FIG. 11, the surfaces 322, 342, which face outward in the radial direction, of all of the plurality of supporting portions 300 are positioned on a common circle in a plane perpendicular to the front-rear direction.

Referring to FIGS. 11 and 14, the terminal 100 is manufactured by punching out a blank from a single metal plate, followed by coining inner surfaces of first supporting portions 320 of the blank in the radial direction, and further followed by bending the blank.

As shown in FIGS. 8 and 9, the terminal 100 has free ends 302 which correspond to the supporting portions 300, respectively. In other words, each of the supporting portions 300 of the present embodiment is not coupled with any of the other supporting portions 300 at a front of the supporting portion 300. Thus, the supporting portions 300 are resiliently deformable independently of each other as described above.

As shown in FIG. 8, in the front-rear direction, each of the free ends 302 of the present embodiment is positioned forward of the contact point 500 which corresponds to the corresponding supporting portion 300. The free end 302 defines a front end of the terminal 100 in the front-rear direction. As shown in FIG. 3, each of the free ends 302 is positioned rearward of the opening 23 in the front-rear direction. Each of the free ends 302 is positioned in the mating terminal accommodating portion 24.

Referring to FIG. 6, each of the contact points 500 of the present embodiment is brought into contact with the mating terminal 850 when the terminal 100 is connected with the mating terminal 850. As shown in FIGS. 8 and 9, the contact points 500 are supported by the supporting portions 300, respectively. Referring to FIG. 10, each of the contact points 500 is movable in the radial direction perpendicular to the front-rear direction.

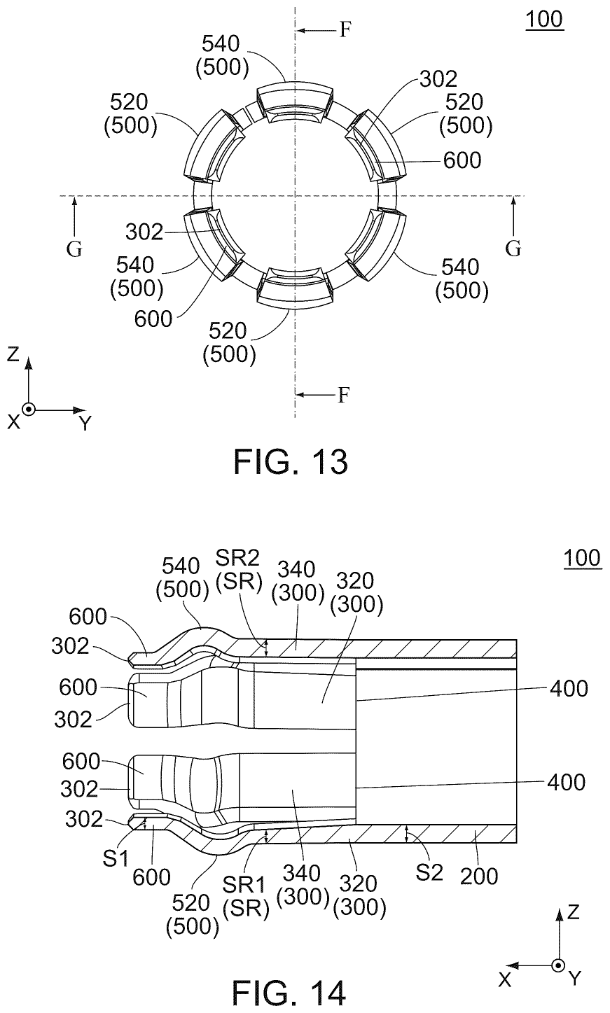

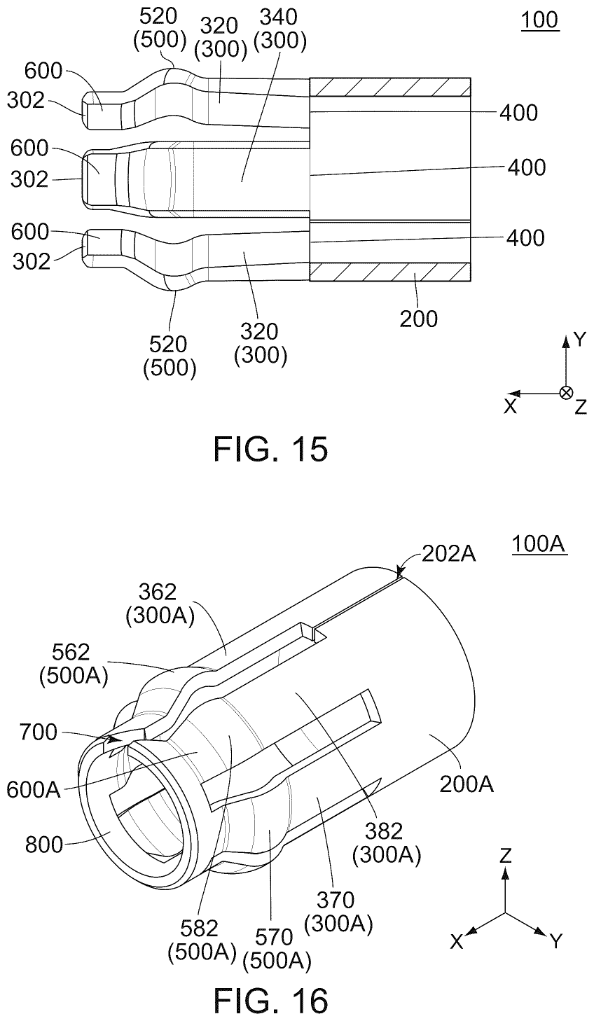

As shown in FIG. 13, each of the contact points 500 of the present embodiment protrudes outward in the radial direction. Referring to FIGS. 6 and 13, an outer surface of the contact point 500 in the radial direction is brought into contact with the mating terminal 850 when the terminal 100 and the mating terminal 850 are mated with each other. However, the present invention is not limited thereto, but the contact point 500 may protrude inward in the radial direction. In other words, the terminal 100 may be configured so that an inner surface of the contact point 500 in the radial direction is brought into contact with the mating terminal 850 when the terminal 100 and the mating terminal 850 are mated with each other.

As described above, the surfaces 322, 342, which face outward in the radial direction, of all of the plurality of supporting portions 300 are positioned on the common circle in the plane perpendicular to the front-rear direction. Accordingly, referring to FIGS. 6 and 13, the terminal 100 of the present embodiment has reduced variation of positions of the contact points 500 in the radial direction which are configured to be brought into contact with the mating terminal 850. This ensures reliable contact of the contact points 500 with the mating terminal 850 when the terminal 100 is connected with the mating terminal 850.

As shown in FIG. 10, the plurality of contact points 500 include contact points 520 and contact points 540. The contact point 520 is also referred to as a first contact point 520. In addition, the contact point 540 is also referred to as a second contact point 540. In other words, the plurality of contact points 500 include the first contact points 520 and the second contact points 540.

As shown in FIG. 14, the first contact points 520 of the present embodiment are resiliently supported by the first supporting portions 320, respectively. The size SR1 of the first supporting portion 320 in the radial direction at a location, which is nearer to the contact point 520 than to the boundary 400 in the front-rear direction, is smaller than the thickness S2 of the base portion 200. Each of the first contact points 520 is positioned rearward of any of the second contact points 540 in the front-rear direction. In other words, each of some contact points 520 is positioned rearward of any of the remaining contact points 540 in the front-rear direction. This reduces an insertion force when the terminal 100 is inserted into the mating terminal 850.

As shown in FIG. 8, the second contact points 540 are resiliently supported by the second supporting portions 340, respectively. Each of the second contact points 540 is positioned forward of any of the first contact points 520 in the front-rear direction.

As described above, in the front-rear direction, the size SX1 of the first supporting portion 320 is smaller than the size SX2 of the second supporting portion 340. Accordingly, in a case where sizes SR of the supporting portions 300 in the radial direction are same as each other, contact pressure of the contact point 520, which is supported by the first supporting portion 320, is expected to be higher than contact pressure of the second contact point 540 which is supported by the second supporting portion 340. However, the size SR1 of the first supporting portion 320 is smaller than the size SR2 of the second supporting portion 340 in the radial direction as described above. This enables the terminal 100 of the present embodiment to reduce the contact pressure of the contact point 520 whose contact pressure is expected to be high in the case where the sizes SR of the supporting portions 300 in the radial direction are same as each other. Thus, variation of the contact pressures of the contact points 500 is within a predetermined range. In other words, the terminal 100 of the present embodiment is configured so that contactability of the contact point 520 is not reduced even if the terminal 100 is repeatedly mated with the mating terminal 850. However, the present invention is not limited thereto. Specifically, in at least one of the circumferential direction and the radial direction, a size of each of the first supporting portions 320 should be, at least in part, smaller than a size of any of the second supporting portions 340. That is, in the at least one of the circumferential direction and the radial direction, the size of each of some supporting portions 320 should be, at least in part, smaller than the size of any of the remaining supporting portions 340. This has the same effect as the terminal 100 of the present embodiment.

As shown in FIG. 10, the first contact points 520 and the second contact points 540 are alternately arranged in the circumferential direction. In other words, each of the first contact points 520 is arranged between two of the second contact points 540 in the circumferential direction, and each of the second contact points 540 is arranged between two of the first contact points 520 in the circumferential direction.

As described above, each of the first contact points 520 is positioned forward of any of the second contact points 540 in the front-rear direction, and the first contact points 520 and the second contact points 540 are alternately arranged in the circumferential direction. In other words, the positions of the contact points 500, which are adjacent to each other in the circumferential direction, are deviated from each other in the front-rear direction. Thus, in the terminal 100 of the present embodiment, the contact points 500 are arranged in a manner where their contact pressures are well-balanced.

As shown in FIGS. 8 and 9, the terminal 100 has a plurality of front end portions 600.

As shown in FIGS. 8 and 9, the front end portions 600 of the present embodiment extend forward in the front-rear direction from the contact points 500, respectively. In the front-rear direction, each of the front end portions 600 is positioned forward of the supporting portion 300 which corresponds to the corresponding contact point 500. The front end portions 600 form the free ends 302, respectively. As shown in FIG. 10, the front end portion 600 is positioned inward of the corresponding contact point 500 in the radial direction. As shown in FIG. 14, a size S1 of the front end portion 600 in the radial direction is smaller than the thickness S2 of the base portion 200. In other words, the front end portion 600 is thinner than the base portion 200. It is noted that the size S1 of the front end portion 600 is smaller than the size SR1 of the first supporting portion 320 in the radial direction. Accordingly, even if the front end portion 600 is resiliently deformed upon the mating of the connector 20 with the mating connector 40, the front end portion 600 can have a distance from a component of the mating connector 40 which is other than the mating terminal 850. Thus, even if the front end portion 600 is resiliently deformed upon the mating of the connector 20 with the mating connector 40, the terminal 100 is prevented from being buckled by abutting against the component.

The structure of the terminal 100 of the connector 20 is not limited thereto. The terminal 100 can be modified, for example, as described below.

Referring to FIG. 16, a terminal 100A according to a modification of the present invention is made of metal. Similar to the terminal 100 of the aforementioned embodiment, the terminal 100A is made from bent plate. In other words, the terminal 100A is not formed by cutting a metal block.

As shown in FIG. 16, the terminal 100A has a base portion 200A, a plurality of contact points 500A, a plurality of front end portions 600A, a slit 700, a coupling portion 800 and a plurality of supporting portions 300A. The base portion 200A has a cylindrical shape.

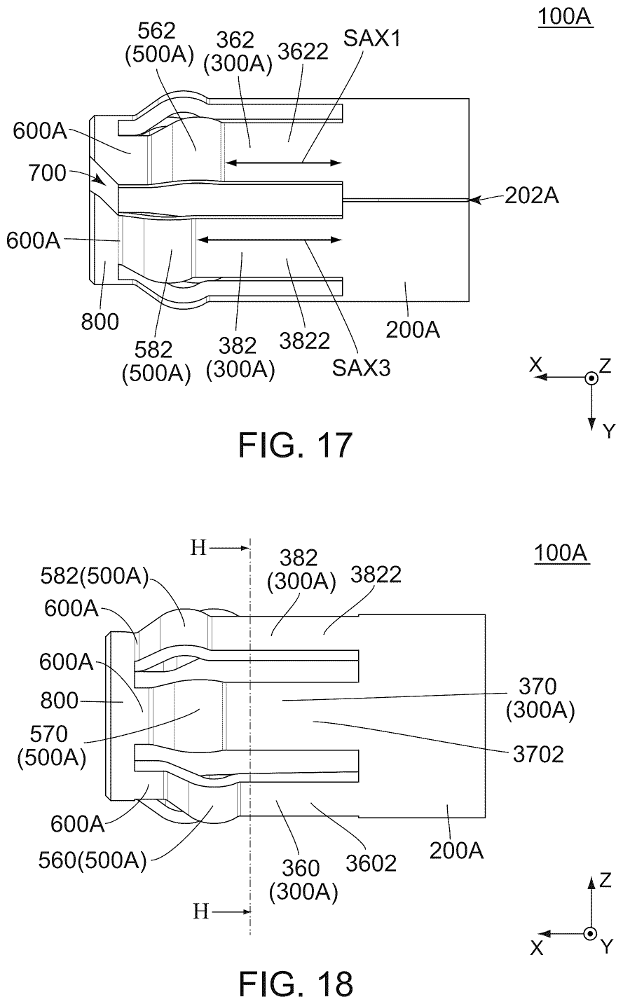

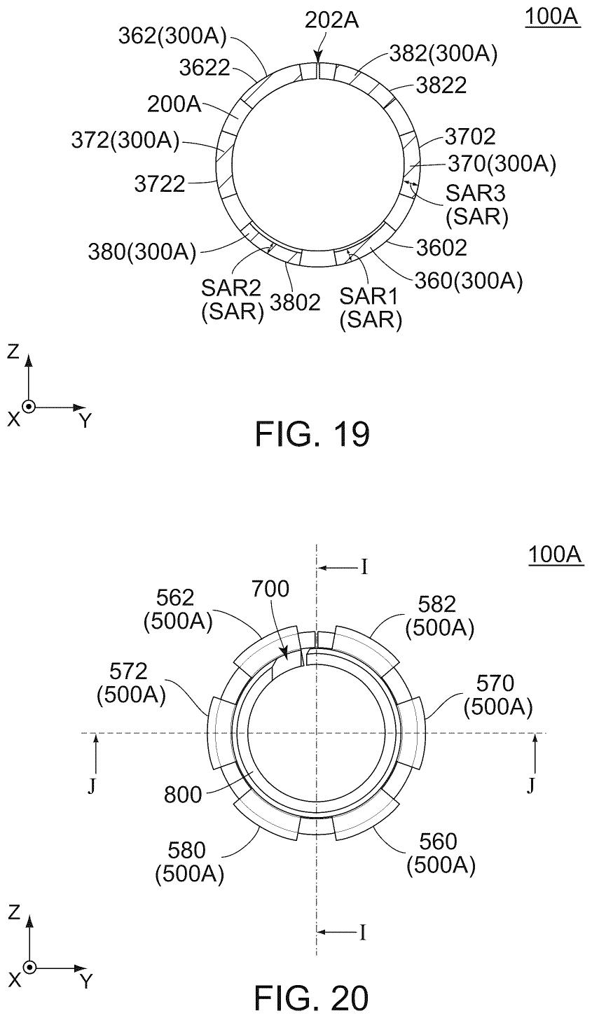

As shown in FIG. 17, the base portion 200A of the present modification extends in the front-rear direction. The base portion 200A defines a rear end of the terminal 100A in the front-rear direction. Referring to FIG. 19, the base portion 200A is formed by bending a plate to form the cylindrical shape so that edges of the plate face each other. The base portion 200A has facing portions 202A. It is noted that the facing portions 202A may be connected with each other by crimping, welding or the like.

Referring to FIGS. 6 and 18, each of the contact points 500A of the present modification is brought into contact with the mating terminal 850 when the terminal 100A is connected with the mating terminal 850. As shown in FIGS. 17 and 18, the contact points 500A are supported by the supporting portions 300A, respectively. Referring to FIG. 20, each of the contact points 500A is movable in the radial direction perpendicular to the front-rear direction.

As shown in FIG. 20, each of the contact points 500A of the present modification protrudes outward in the radial direction. Referring to FIGS. 6 and 20, an outer surface of the contact point 500A in the radial direction is brought into contact with the mating terminal 850 when the terminal 100A and the mating terminal 850 are mated with each other. However, the present invention is not limited thereto, but the contact point 500A may protrude inward in the radial direction. In other words, the terminal 100A may be configured so that an inner surface of the contact point 500A in the radial direction is brought into contact with the mating terminal 850 when the terminal 100A and the mating terminal 850 are mated with each other.

As shown in FIG. 20, the plurality of contact points 500A include contact points 560, 562, contact points 570, 572 and contact points 580, 582. The contact point 560, 562 is also referred to as a first contact point 560, 562. In addition, the contact point 570, 572 is also referred to as a second contact point 570, 572. Further, the contact point 580, 582 is also referred to as a third contact point 580, 582. In other words, the plurality of contact points 500A include the first contact points 560, 562, the second contact points 570, 572 and the third contact points 580, 582.

As understood from FIGS. 17, 18, 21 and 22, each of the first contact points 560, 562 is positioned rearward of any of the second contact points 570, 572 and the third contact points 580, 582 in the front-rear direction. Each of the second contact points 570, 572 is positioned forward of any of the first contact points 560, 562 in the front-rear direction. Each of the second contact points 570, 572 is positioned rearward of any of the third contact points 580, 582 in the front-rear direction. Each of the third contact points 580, 582 is positioned forward of any of the first contact points 560, 562 and the second contact points 570, 572 in the front-rear direction.

As shown in FIGS. 17 and 18, the front end portions 600A of the present modification extend forward in the front-rear direction from the contact points 500A, respectively.

As shown in FIG. 20, the slit 700 of the present modification splits the coupling portion 800 in the circumferential direction. The number of the slit 700 of the present modification is one.

As shown in FIG. 20, the coupling portion 800 of the present modification has a C-shape. As understood from FIGS. 17 and 18, the coupling portion 800 couples the front end portions 600A with each other except for the slit 700.

Referring to FIGS. 17 and 18, each of the supporting portions 300A of the present modification is resiliently deformable. Each of the supporting portions 300A extends forward in the front-rear direction from the base portion 200A. As described above, the contact points 500A are supported by the supporting portions 300A, respectively, the front end portions 600A extend forward from the contact points 500A, respectively, and the coupling portion 800 couples the front end portions 600A with each other except for slit 700. Thus, unlike to the supporting portions 300 of the aforementioned embodiment, the supporting portions 300A of the present modification are not independent from each other. As shown in FIG. 19 the supporting portions 300A are arranged in the circumferential direction about the axis parallel to the front-rear direction.

As shown in FIGS. 17 and 18, the plurality of supporting portions 300A include supporting portions 360, 362, supporting portions 370, 372 and supporting portions 380, 382. Hereinafter, the supporting portion 360, 362 is also referred to as a first supporting portion 360,362. In addition, the supporting portion 370, 372 is also referred to as a second supporting portion 370, 372. Furthermore, the supporting portion 380, 382 is also referred to as a third supporting portion 380, 382.

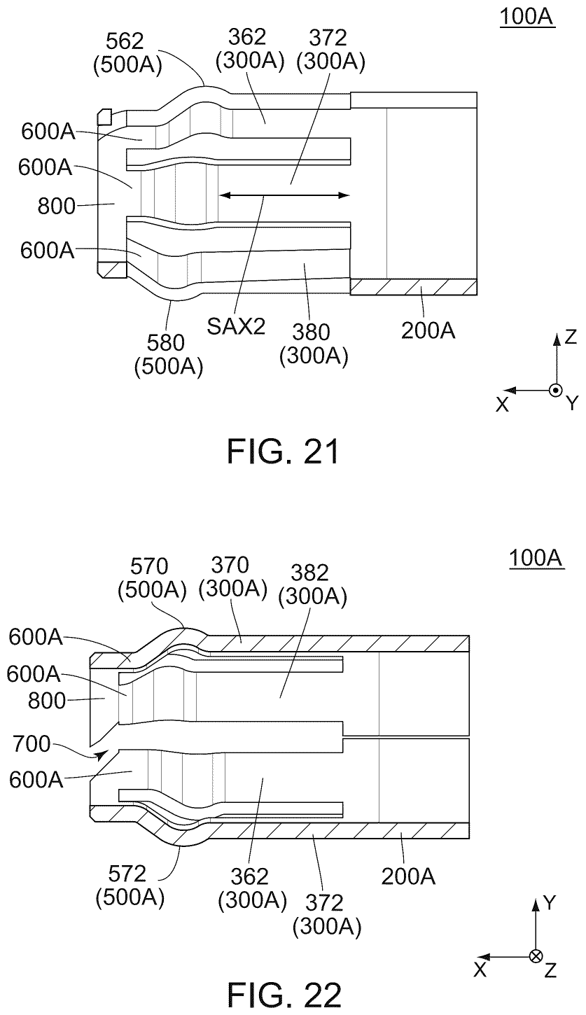

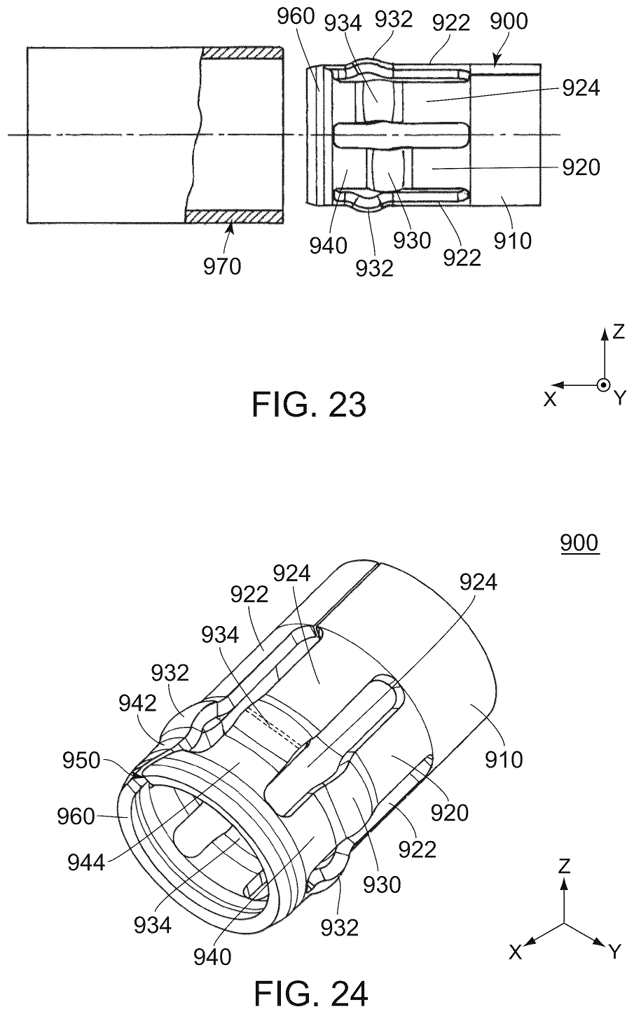

Referring to FIGS. 17 and 21, in the front-rear direction, a size SAX1 of each of the first supporting portions 360, 362 is smaller than any of sizes SAX2 of the second supporting portions 370, 372 and sizes SAX3 of the third supporting portions 380, 382. As shown in FIG. 19, the first supporting portions 360, 362 are arranged to face each other in the radial direction. The first supporting portion 360 is positioned between the second supporting portion 370 and the third supporting portion 380 in the circumferential direction. The first supporting portion 362 is positioned between the second supporting portion 372 and the third supporting portion 382 in the circumferential direction. The first supporting portion 360 has a surface 3602 which faces outward in the radial direction. The first supporting portion 362 has a surface 3622 which faces outward in the radial direction.

Referring to FIGS. 17 and 21, the size SAX2 of each of the second supporting portions 370, 372 is larger than the size SAX1 of any of the first supporting portions 360, 362 in the front-rear direction. The size SAX2 of each of the second supporting portions 370, 372 is smaller than the size SAX3 of any of the third supporting portions 380, 382 in the front-rear direction. As shown in FIG. 19, the second supporting portions 370, 372 are arranged to face each other in the radial direction. The second supporting portion 370 is positioned between the first supporting portion 360 and the third supporting portion 382 in the circumferential direction. The second supporting portion 372 is positioned between the first supporting portion 362 and the third supporting portion 380 in the circumferential direction. The second supporting portion 370 has a surface 3702 which faces outward in the radial direction. The second supporting portion 372 has a surface 3722 which faces outward in the radial direction.

Referring to FIGS. 17 and 21, the size SAX3 of each of the third supporting portions 380, 382 is larger than any of the sizes SAX1 of the first supporting portions 360, 362 and the sizes SAX2 of the second supporting portions 370, 372 in the front-rear direction. As shown in FIG. 19, the third supporting portions 380, 382 are arranged to face each other in the radial direction. The third supporting portion 380 is positioned between the first supporting portion 360 and the second supporting portion 372 in the circumferential direction. The third supporting portion 382 is positioned between the first supporting portion 362 and the second supporting portion 370 in the circumferential direction. The third supporting portion 380 has a surface 3802 which faces outward in the radial direction. The third supporting portion 382 has a surface 3822 which faces outward in the radial direction.

As shown in FIGS. 17 and 18, the first contact point 560 is resiliently supported by the first supporting portion 360, and the first contact point 562 is resiliently supported by the first supporting portion 362. As shown in FIG. 22, the second contact point 570 is resiliently supported by the second supporting portion 370, and the second contact point 572 is resiliently supported by the second supporting portion 372. As shown in FIGS. 17 and 21, the third contact point 580 is resiliently supported by the third supporting portion 380, and the third contact point 582 is resiliently supported by the third supporting portion 382.

As described above, each of the first contact points 560, 562 is positioned rearward of any of the second contact points 570, 572 and the third contact points 580, 582 in the front-rear direction. In other words, each of some contact points 560, 562 is positioned rearward of any of the remaining contact points 570, 572, 580, 582 in the front-rear direction. This reduces an insertion force when the terminal 100A is inserted into the mating terminal 850.

As shown in FIG. 19, the supporting portions 362, 370, 372, 382 have sizes SAR3 same as each other in the radial direction.

Referring to FIGS. 19 and 20, the supporting portions 360, 380 of the plurality of supporting portions 300A are positioned farthest from the slit 700 among the plurality of supporting portions 300A. Accordingly, contact pressure of each of the contact points 560, 580, which are supported by the supporting portions 360, 380, is expected to be highest among contact pressures of the contact points 500A in a case where sizes SAR of the supporting portions 300A in the radial direction are same as each other.

As shown in FIG. 19, in the radial direction, a size SAR1 of the supporting portion 360 is smaller than the size SAR3 of any of the supporting portions 362, 370, 372, 382. In the radial direction, a size SAR2 of the supporting portion 380 is smaller than the size SAR3 of any of the supporting portions 362, 370, 372, 382. This enables the terminal 100A of the present modification to reduce the contact pressures of the contact points 560, 580 whose contact pressures are expected to be high in the case where the sizes SAR of the supporting portions 300A in the radial direction are same as each other. Thus, variation of the contact pressures of the contact points 500A is within a predetermined range. In other words, the terminal 100A of the present modification is configured so that contactability of the contact point 500A is not reduced even if the terminal 100A is repeatedly mated with the mating terminal 850. However, the present invention is not limited thereto. Specifically, in at least one of the circumferential direction and the radial direction, a size of each of some supporting portions 360, 380 should be, at least in part, smaller than a size of any of the remaining supporting portions 362, 370, 372, 382. This has the same effect as the terminal 100A of the present modification.

Although the terminal 100A of the aforementioned modification is configured so that the two supporting portions 360, 380 are positioned farthest from the slit 700 among the supporting portions 300A, the present invention is not limited thereto. Specifically, the terminal 100A may be modified so that one of the supporting portions 300A is positioned farthest from the slit 700 among the supporting portions 300A. More specifically, the terminal 100A may be configured as follows: one or two of the plurality of supporting portions 300A is/are positioned farthest from the slit 700 among the plurality of supporting portions 300A; and, in at least one of the circumferential direction and the radial direction, size(s) of the one or two supporting portion(s) 300A is/are, at least in part, smaller than a size of any of remaining ones of the supporting portions 300A. This has the same effect as the terminal 100A of the present modification.

As shown in FIG. 19, the surfaces 3602, 3622, 3702, 3722, 3802, 3822, which face outward in the radial direction, of all of the plurality of supporting portions 300A are positioned on a common circle in the plane perpendicular to the front-rear direction. Accordingly, referring to FIGS. 6 and 20, the terminal 100A of the present modification has reduced variation of positions of the contact points 500A in the radial direction which are configured to be brought into contact with the mating terminal 850. This ensures reliable contact of the contact points 500A with the mating terminal 850 when the terminal 100A is connected with the mating terminal 850.

Referring to FIG. 19, the terminal 100A is manufactured by punching out a blank from a single metal plate, followed by coining inner surfaces of support portions 360, 380 of the blank in the radial direction, and further followed by bending the blank.

Although the specific explanation about the present invention is made above referring to the embodiments, the present invention is not limited thereto and is susceptible to various modifications and alternative forms.

Although the terminal 100A of the present modification has the single slit 700, the present invention is not limited thereto. Specifically, the terminal 100A may have two or more of the slits 700. Also, in this case, the size of the supporting portion 300A, which is positioned farthest from the slits 700 among the plurality of supporting portion 300A, must be, at least in part, smaller than the size of any of remaining ones of the supporting portions 300A in at least one of the circumferential direction and the radial direction. This has the same effect as the terminal 100A of the present modification.

The present application is based on a Japanese patent application of JP2021-206097 filed before the Japan Patent Office on Dec. 20, 2021, the content of which is incorporated herein by reference.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

### REFERENCE SIGNS LIST

10 assembly
20 connector
22 holding member
23 opening
24 mating terminal accommodating portion
40 mating connector
42 mating holding member
100, 100A terminal
200, 200A base portion
202, 202A facing portion
300, 300A supporting portion
302 free end
320 first supporting portion (supporting portion)
322 surface
340 second supporting portion (supporting portion)
342 surface
360 first supporting portion (supporting portion)
3602 surface
362 first supporting portion (supporting portion)
3622 surface
370 second supporting portion (supporting portion)
3702 surface
372 second supporting portion (supporting portion)
3722 surface
380 third supporting portion (supporting portion)
3802 surface
382 third supporting portion (supporting portion)
3822 surface
400 boundary
500, 500A contact point
520 first contact point (contact point)
540 second contact point (contact point)
560 first contact point (contact point)
562 first contact point (contact point)
570 second contact point (contact point)
572 second contact point (contact point)
580 third contact point (contact point)
582 third contact point (contact point)
600, 600A front end portion
700 slit
800 coupling portion
850 mating terminal
S1 size
S2 thickness
SR size
SR1 size
SR2 size
SX1 size
SX2 size
SAR size
SAR1 size
SAR2 size
SAR3 size
SAX1 size
SAX2 size
SAX3 size

1. A terminal connectable with a mating terminal in a front-rear direction, wherein:
the terminal has a base portion, a plurality of supporting portions and a plurality of contact points;
the base portion has a cylindrical shape;
each of the supporting portions is resiliently deformable and extends forward in the front-rear direction from the base portion;
the supporting portions are arranged in a circumferential direction about an axis parallel to the front-rear direction;
each of the contact points is brought into contact with the mating terminal when the terminal is connected with the mating terminal;
the contact points are supported by the supporting portions, respectively;
each of the contact points is movable in a radial direction perpendicular to the front-rear direction;
each of some of the contact points is positioned rearward of any of remaining ones of the contact points in the front-rear direction; and
in at least one of the circumferential direction and the radial direction, a size of each of some of the supporting portions is, at least in part, smaller than a size of any of remaining ones of the supporting portions.

2. The terminal as recited in claim 1, wherein:
the terminal has a plurality of front end portions, a slit and a coupling portion;
the front end portions extend forward in the front-rear direction from the contact points, respectively;
the coupling portion has a C-shape and couples the front end portions with each other expect for the slit;
one or two of the plurality of supporting portions is/are positioned farthest from the slit among the plurality of supporting portions; and
in at least one of the circumferential direction and the radial direction, size(s) of the one or two supporting portion(s) is/are, at least in part, smaller than a size of any of remaining ones of the supporting portions.

3. The terminal as recited in claim 1, wherein:
the supporting portions are independent from each other;
the terminal has boundaries between the base portion and each of the supporting portions;
the boundaries are positioned at positions same as each other in the front-rear direction;
the terminal has free ends which correspond to the supporting portions, respectively;
in the front-rear direction, each of the free ends is positioned forward of the contact point which corresponds to the corresponding supporting portion;
the plurality of supporting portions include a first supporting portion and a second supporting portion;
in the front-rear direction, a size of the first supporting portion is smaller than a size of the second supporting portion; and
in at least one of the circumferential direction and the radial direction, a size of the first supporting portion is, at least in part, smaller than a size of the second supporting portion.

4. The terminal as recited in claim 3, wherein:
each of the contact points protrudes outward in the radial direction;
each of the supporting portions has a surface which faces outward in the radial direction; and
the surfaces of all of the plurality of supporting portions are positioned on a common circle in a plane perpendicular to the front-rear direction.

5. The terminal as recited in claim 3, wherein:
the terminal has a plurality of front end portions;
the front end portions extend forward in the front-rear direction from the contact points, respectively;
the front end portions form the free ends, respectively; and
each of the front end portions is thinner than the base portion.

6. The terminal as recited in claim 1, wherein the terminal is made from bent plate.
